(19) United States
(12) Patent Application Publication
(10) Pub. No.: US 2015/0067742 A1
(43) Pub. Date: Mar. 5, 2015

(54) METHOD AND SYSTEM FOR CONTEXT BASED SPLITTING AND TRANSMISSION OF BROADCAST CONTENT

(71) Applicant: Tata Consultancy Services Limited, Mumbai (IN)

(72) Inventors: Aniruddha Sinha, Kolkata (IN); Tanushyam Chattopadhyay, Kolkata (IN); Chirabrata Bhaumik, Kolkata (IN); Arpan Pal, Kolkata (IN)

(21) Appl. No.: 14/387,086

(22) PCT Filed: Mar. 19, 2013
(86) PCT No.: PCT/IN2013/000175

§ 371 Date: Sep. 22, 2014

(30) Foreign Application Priority Data
Mar. 26, 2012 (IN) 813/MUM/2012

(51) Int. Cl. H04N 21/454; H04N 7/10; H04N 21/45; H04N 21/41; H04L 29/06; H04N 21/436

(52) U.S. Cl. CPC H04N 21/454; H04L 65/60; H04N 21/43615; H04N 21/4532; H04N 21/4104; H04N 7/106
USPC 725/80; 725/110

(57) ABSTRACT

A method and system is provided for context based splitting of a broadcast content stream and transmission of a relevant broadcast content out of said broadcast content stream to at least one edge device over a home area network for consumption. Particularly, the invention provides a method and system for obtaining context of the edge device and corresponding device owner; comparing the said obtained context with the broadcast content stream; finding and splitting relevant broadcast content out of the broadcast content stream according to the context of said edge device; and transmitting said relevant broadcast content to said edge device for future consumption.

### FIELD OF THE INVENTION

The present invention relates to broadcast. Particularly the invention provides a method and system for context based splitting of a broadcast content stream and transmission of relevant broadcast content to an edge device stream over a home area network for future consumption.

### BACKGROUND OF THE INVENTION

As a technology, digital as well analog both are being used in television broadcast. However, television transmission is being transitioned from analog to digital. The digital television broadcast signal communication is done either through satellite or terrestrial system. A standard digital or analog receiver such as set top box receives the broadcast content, demodulates the RF signal, de-multiplexes the transport stream, decodes and further displays a particular program channel. A broadcast content stream of a particular program channel as a whole may not be of interest to all the viewers at the time of display on the television. Thus users may get overloaded with such non relevant information telecasted on the television.

The major challenge in the broadcast such as television broadcast is to identify user preferences through obtaining user context, user device's context and accordingly transmitting preferred television broadcast content out of the television broadcast content stream. The user may not always be interested in receiving television broadcast on the television. Due to proximity with the television screen or relevancy of the said television broadcast content to a particular edge device, user may want television broadcast to be received on its secondary edge device. Thus, identifying relevant broadcast content according to user's context and further transmitting the same to the user's secondary edge devices based on the context of the user as well user device is another challenge which is still unaddressed.

Hence there is a need for a method and system which could obtain and consider edge device and edge device owner's context for splitting of a broadcast content stream and further transmit relevant broadcast content out of said broadcast content stream to at least one edge device stream over a home area network for future consumption. Some of the existing method and systems known to us are as follows:

U.S. 20120030064 by Flinn et al. describes about generating recommendations based on usage behaviors, including physiological responses such as body movements and gestures.

U.S. 20110153452 by Flinn et al. describes about a context-sensitive, adaptive commerce that features recommendations of products and/or services based on system usage behaviors and supplier contextual information such as inventory levels.

U.S. 2001025375 by Ahmad et al. describes about categorization of uncategorized segments of the body of information based upon comparison to other segments of the body of information that have been categorized.

U.S. 2002162118 by Levy et al. describes about content identifiers, provided to uniquely identify content, or a subset of the content. The content identifiers are used to index corresponding interactive data.

U.S. Pat. No. 7,213,005 to Mourad et al. describes about a method of securely receiving data on a user's system from a web broadcast infrastructure with a plurality of channels.

Mercer et. al. in “An Approach towards the Exploration of User Preference Adaptation for Cross Device, Cross Context Video Content Recommenders in Web 2.0 Environments” describes about advocates an approach which investigates preference adaptation from the perspective of users self moderating content choices in response to perceptions of the current viewing context.

The above mentioned prior arts fail to disclose an efficient method and system that consider both edge device and edge device owner's context for further transmitting relevant broadcast content based on the said context to the edge device stream over a home area network for future consumption. Thus, in the light of the above mentioned background art, it is evident that, there is a need for a solution that obtain and consider both edge device and edge device owner's context for further transmitting relevant broadcast content based on the said context to edge device stream over a home area network for consumption.

### OBJECTIVES OF THE INVENTION

In accordance with the present invention, the primary objective is to provide a method and system for context based splitting of a broadcast content stream and transmission of a relevant broadcast content out of said broadcast content stream to at least one edge device over a home area network for future consumption.

Another objective of the invention is to provide a method and system for obtaining context of the edge device and corresponding device owner.

Another objective of the invention is to provide a method and system for comparing the context of edge device and the device owner with the broadcast content stream.

Another objective of the invention is to provide a method and system for finding relevant broadcast content out of the broadcast content stream according to the context of said edge device and the device owner based on the said comparison.

Another objective of the invention is to provide a method and system for splitting said relevant broadcast content out of the broadcast content stream and transmitting said relevant broadcast content to the edge device for consumption.

### SUMMARY OF THE INVENTION

Before the present methods, systems, and hardware enablement are described, it is to be understood that this invention in not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention.

The present invention provides a method and system for context based splitting of a broadcast content stream and transmission of a relevant broadcast content out of said broadcast content stream to at least one edge device over a home area network for future consumption.

In an embodiment of the invention a method is provided for obtaining context of at least one edge device and corresponding device owner using at least one sensor communicatively coupled with said edge device; comparing the said obtained context of edge device and the device owner with the broadcast content stream received by a set top box; finding relevant broadcast content out of the broadcast content stream according to the context of said edge device and the device owner based on the said comparison; and splitting said relevant broadcast content out of the broadcast content stream based on the said context and transmitting said relevant broadcast content to said edge device for future consumption.

In an embodiment of the invention a system is provided for context based splitting of a broadcast content stream and transmission of a relevant broadcast content out of said broadcast content stream to at least one edge device over a home area network for consumption, wherein the system comprises of at least one sensor; at least one edge device and a set top box, wherein said sensor is communicatively coupled with edge device and adapted to obtain context of the edge device and corresponding device owner; said set top box adapted to receive and further transmit said broadcast content stream; compare the said obtained context of edge device and the device owner with the broadcast content stream received by the set top box; find relevant broadcast content out of the broadcast content stream according to the obtained context of said edge device and the device owner based on the said comparison; split said relevant broadcast content out of the broadcast content stream based on the said context and transmit said relevant broadcast content to said edge device; and said edge device is adapted to consume a relevant broadcast content out of the broadcast content stream transmitted by said set top box.

The above said method and system are preferably for context based splitting of a broadcast content stream and transmission of a relevant broadcast content out of said broadcast content stream to at least one edge device for future consumption but also may be used for many other applications.

### BRIEF DESCRIPTION OF THE DRAWINGS

The foregoing summary, as well as the following detailed description of preferred embodiments, are better understood when read in conjunction with the appended drawings. For the purpose of illustrating the invention, there is shown in the drawings exemplary constructions of the invention; however, the invention is not limited to the specific methods and system disclosed. In the drawings:

FIG. 1: shows a flow diagram of the method for context based splitting and transmission of broadcast content.

FIG. 2: shows a system diagram for context based splitting and transmission of broadcast content.

### DETAILED DESCRIPTION OF THE INVENTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The disclosed embodiments are merely exemplary of the invention, which may be embodied in various forms.

The present application provides a method for transmitting a relevant broadcast content out of a broadcast content stream over a home area network (200), the said method comprises processor implemented steps of:
a. obtaining context of at least one edge device (206) and corresponding device owner using at least one sensor (208) communicatively coupled with said edge device (206);
b. comparing the said obtained context of edge device (206) and the device owner with the broadcast content stream received by a set top box (202);
c. finding relevant broadcast content out of the broadcast content stream according to the context of said edge device (206) and the device owner based on the said comparison; and
d. splitting said relevant broadcast content out of the broadcast content stream based on the said context and transmitting said relevant broadcast content to said edge device (206) for future consumption.

The present application provides a system for transmitting a relevant broadcast content out of a broadcast content stream over a home area network (200), the system comprising of at least one sensor (208); at least one edge device (206) and a set top box (202), wherein said sensor (208) is communicatively coupled with edge device and adapted to obtain context of the edge device and corresponding device owner; said set top box (202) adapted to receive and further transmit said broadcast content stream; compare the said obtained context of edge device (206) and the device owner with the broadcast content stream received by the set top box (202); find relevant broadcast content out of the broadcast content stream according to the obtained context of said edge device (206) and the device owner based on the said comparison; split said relevant broadcast content out of the broadcast content stream based on the said context and transmit said relevant broadcast content to said edge device (206); and said edge device (206) is adapted to consume a relevant broadcast content out of the broadcast content stream transmitted by said set top box (202).

The invention provides a method and system for context based splitting of a broadcast content stream and transmission of a relevant broadcast content out of said broadcast content stream to an edge device over a home area network for future consumption.

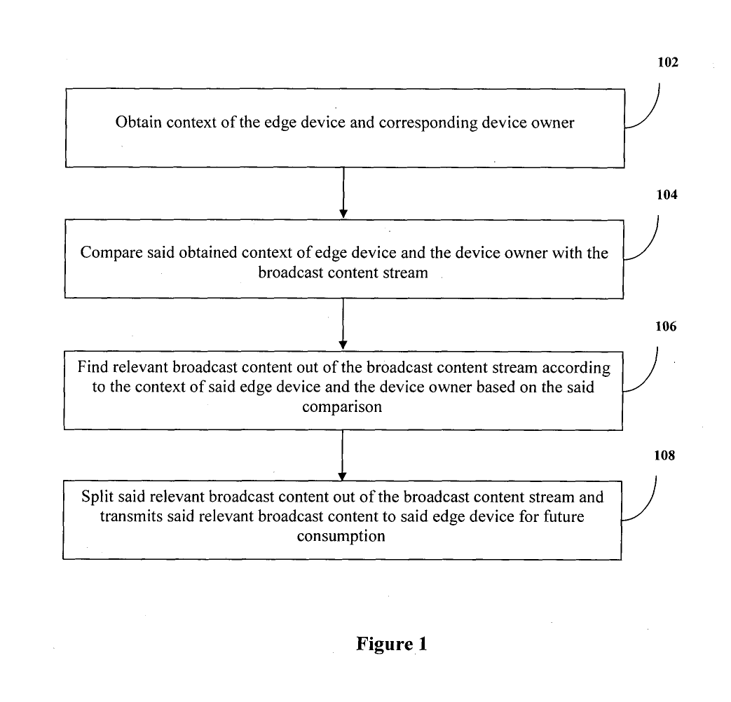

Referring to FIG. 1 is a flow diagram of the method for context based splitting and transmission of broadcast content.

The process starts at the step 102, context of the edge device and corresponding device owner is obtained. At the step 104, said obtained context of edge device and the device owner is compared with the broadcast content stream. At the step 106, relevant broadcast content out of the broadcast content stream is found according to the context of said edge device and the device owner based on the said comparison. The process ends at the step 108, said relevant broadcast content is split out of the broadcast content stream and said relevant broadcast content is transmitted to the said edge device for future consumption.

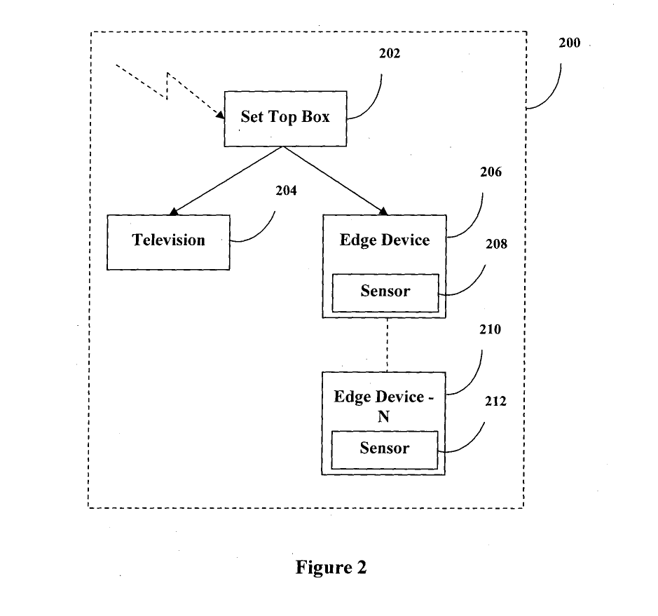

Referring to FIG. 2 is a system diagram for context based splitting and transmission of broadcast content.

In an embodiment of the invention, a system is provided for context based splitting of a broadcast content stream and transmission of a relevant broadcast content out of said broadcast content stream to at least one edge device over a home area network (200) for future consumption, wherein the said system comprises of at least one sensor (208); at least one edge device (206) and a set top box (202), wherein said sensor (208) is communicatively coupled with edge device and adapted to obtain context of the edge device and corresponding device owner; said set top box (202) adapted to receive and further transmit said broadcast content stream; compare the said obtained context of edge device (206) and the device owner with the broadcast content stream received by the set top box (202); find relevant broadcast content out of the broadcast content stream according to the obtained context of said edge device (206) and the device owner based on the said comparison; split said relevant broadcast content out of the broadcast content stream based on the said context and transmit said relevant broadcast content to said edge device (206); and said edge device (206) is adapted to consume a relevant broadcast content out of the broadcast content stream transmitted by said set top box (202).

In an embodiment of the invention, the context of the edge device (206) and corresponding device owner is obtained using said sensor (208) communicatively coupled with said edge device (206). In the similar manner there could be more than one edge device up till edge device—N (212) and its corresponding sensor—N (210). The said context of the edge device owner is based on the device owner's presence, preferences, intentions, surroundings in the proximity to the said edge device (206) and preferences for a particular type of broadcast content such as advertisement.

The edge device (206) is selected from the group comprising of but not limited to a smart phone, a laptop, a tablet personal computer, a smart refrigerator, a smart microwave, a smart washing machine, a smart electrical meter and smart furniture. The context of the edge device (206) is obtained based on the current state of the said edge device (206). The current states for smart and intelligent consumer electronic devices such as refrigerator washing machine, or microwave may be selected from the group comprising of empty or full etc. and for other it may be busy or idle. All the states may not be valid for all devices and may depend in the type of the edge device (206). In case of smart and intelligent consumer electronic devices such as refrigerator, washing machine, microwave, communicatively coupled with sensors and having small console, they may be intelligent enough to know their own current state and communicate the same to the set top box (202) or other devices such as home gateway.

In an embodiment of the invention, the obtained context of edge device and the device owner are then compared with the broadcast content stream received by a set top box (202).

In an embodiment of the invention, the relevant broadcast content is found out of the broadcast content stream according to the context of said edge device and the device owner based on the said comparison.

In an embodiment of the invention, the relevant broadcast content is split out of the broadcast content stream and transmitting said relevant broadcast content to said edge device (206) over a home area network (200) for future consumption, wherein the consumption may include instant display, display at predetermined time, display determined by the proximity of said edge device (206), store or combination thereof.

In an embodiment of the invention, the edge device (206) are having sensor (208) for continuously monitor and obtaining the context of the device and device owner. The edge device (206) may or may not have a display means associated with it, such as a display panel. When the edge device (206) is having display means said relevant broadcast content out of said broadcast content stream is displayed on the edge device (206). When the edge device (206) is not having display means such as a display panel, said relevant broadcast content out of said broadcast content stream is stored in the edge device (206) itself and further said stored relevant broadcast content out of said broadcast content stream is displayed on another edge device having a display means. In case, the edge device (206) is having no storage means, said relevant broadcast content out of said broadcast content stream of the edge device (206) is stored in said set top box (202).

In a specific embodiment of the present invention, a television (204) displays all the broadcast content that it received from the set top box (202). For an example, in news channel, there may be three or four types of unrelated information cluttered on the television (204) screen. With the objective of showing minimum and relevant information on the television (204) screen, the remaining which may be some old news or related to stock related business information or some advertisements; may be send to the edge device (206) based on type of television broadcast content and the device or device owner's context. In particularly, the advertisements may be more targeted for a particular device or device owner. Apart from the generic advertisements, the broadcast information may contain some specific advertisements related to the household consumer electronic following which may be transmitted to relevant smart edge devices based on the device context and the device owner's context. For an example certain food items butter, jam or may be some fruits available in a shopping mall chain, certain microwave pre-cooked packetized foods, smart electrical appliances or promotional offers on furniture items. Based on the device or device owner's context these advertisements may not be displayed on the televisions (204) screen, rather they may be pushed to the relevant edge device (206) such as smart refrigerator, smart microwave, smart electrical meter and smart furniture. This information is then consumed by the device owner based on the usage of the devices.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal displays (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

1-10. (canceled)

11. A method for transmitting relevant content of a broadcast stream over a network, the method performed by at least one processor and comprising:
obtaining a context of at least one edge device and a context of at least one user of the edge device;
transmitting, to a set to box, the context of the edge device and the context of the user; and
receiving, at the edge device from the set top box, relevant broadcast content;
wherein the relevant broadcast content is identified among content received in a broadcast stream at the set top box based on a comparison of the context of the edge device and the context of the user with the content received in the broadcast stream.

12. The method of claim 11, wherein the edge device displays the relevant broadcast content based on the user's proximity to the edge device.

13. The method of claim 11, wherein the context of the edge device is obtained based on a current state of the edge device.

14. The method of claim 11, wherein the context of the user includes at least one of the user's presence, preferences, intentions, proximity to the edge device, or preferences for a type of broadcast content.

15. The method of claim 11, wherein the edge device is at least one of a smart phone, a laptop, a tablet personal computer, a smart refrigerator, a smart microwave, a smart washing machine, a smart electrical meter or a smart furniture.

16. The method of claim 11, wherein the context of the edge device includes a type of edge device.

17. The method of claim 11, further comprising:
transmitting, by the edge device to another edge device, the relevant broadcast content for display on the other edge device.

18. The method of claim 11, wherein the network comprises a home area network.

19. A system for transmitting relevant content of a broadcast stream over a network, the system comprising:
at least one edge device; and
at least one sensor communicatively coupled to the edge device and adapted for obtaining a context of the edge device and a context of a user of the edge device;
wherein the edge device is adapted for:
transmitting, to a set top box, the context of the edge device and the context of the user; and
receiving, from the set top box, relevant broadcast content; and
wherein the relevant broadcast content is identified among content received in a broadcast stream at the set top box based on a comparison of the context of the edge device and the context of the user with the content received in the broadcast stream.

20. The system of claim 19, wherein the edge device is further adapted for displaying the relevant broadcast content based on the user's proximity to the edge device.

21. The system of claim 19, wherein at least one sensor is adapted for obtaining the context of the edge device based on a current state of the edge device.

22. The system of claim 19, wherein the context of the user includes at least one of the user's presence, preferences, intentions, proximity to the edge device, or preferences for a type of broadcast content

23. The system of claim 19, wherein the edge device is at least one of a smart phone, a laptop, a tablet personal computer, a smart refrigerator, a smart microwave, a smart washing machine, a smart electrical meter or a smart furniture.

24. The system of claim 19, wherein the context of the edge device includes a type of edge device.

25. The system of claim 19, wherein the network comprises a home area network.

26. A method for transmitting relevant content of a broadcast stream over a network, the method performed by at least one processor and comprising:
receiving, at a set top box, a context of at least one edge device and a context of at least one user of the edge device;
comparing, by the set top box, the context of the edge device and the context of the user with content received in a broadcast stream;
identifying, based on the comparison, relevant content among the content received in the broadcast stream; and
transmitting the identified relevant content to the edge device .

27. The method of claim 26, wherein the context of the user includes at least one of the user's presence, preferences, intentions, proximity to the edge device, or preferences for a type of broadcast content.

28. The method of claim 26, wherein the edge device is at least one of a smart phone, a laptop, a tablet personal computer, a smart refrigerator, a smart microwave, a smart washing machine, a smart electrical meter or a smart furniture.

29. The method of claim 26, wherein the context of the edge device includes a type of edge device.

30. The method of claim 26, wherein the network comprises a home area network.
